(19) United States
(12) Patent Application Publication
(10) Pub. No.: US 2007/0007306 A1
(43) Pub. Date: Jan. 11, 2007

(54) Soap dispenser extruding device

(76) Inventor: Yeng-Tang Lin, Wu Chi Chen (TW)

Correspondence Address: LEONG C LEI, PMB # 1008, 1867 YGNACIO VALLEY ROAD, WALNUT CREEK, CA, 94598, US

(21) Appl. No.: 11/177,389

(22) Filed: Jul. 11, 2005

(51) Int. Cl. B65D 88/54; G01F 11/00

(52) U.S. Cl. 222/321.7; 222/341

(57) ABSTRACT

A soap dispenser extruding device that decrease operation resistance, release the restriction of liquid outlet orientation, increase the working efficiency of a soap dispenser and product cost saving are the key points, besides there are also functions of non soap liquid to be overflow before soap dispenser in service or no any soap liquid residues to be left after soap dispenser in service. A piston rod is moving back and forth against a spring in piston bush, activating a ball checking valve for controlling of flowing soap liquid from soap liquid container to piston bush. Another checking valve located in the end of the hollow part of piston rod is for controlling flowing of soap fluid from piston bush to liquid outlet. When piston rod is pushing in, this is soap dispenser in service; when piston is spring back; a suction force is absorbing residue in outlet; this is soap dispenser out of service.

### BACKGROUND OF THE INVENTION

(a) Field of the Invention

The present invention is related to a soap dispenser extruding device. Such invention make possible the installing of the piston rod and piston bush of the extruding device in the space of container, and separating the operating system from soap liquid feeding system. Therefore the operating resistance and the limitation of soap liquid outlet position could be decreased. Such effects would result in increase soap dispenser efficiency, energy saving for operation, and the economical effect of product cost deduction for assembling a soap dispenser on line.

(b) Description of the Prior Art

There are two different functions of the soap dispenser to be sold in current market, one is the wall adhering type and the other is the vertical type. The liquid soap container of wall adhering type is in the up and down position. The soap liquid extrudes out by a horizontal pressing operation. But this pressing operation activation is hard because of resistance due to the improper design of the shaft rod and shaft ring. In correspondence with such defaults of the current marking soap dispenser, there are several improved designs which have emerged, such as “improvement of pushing mechanism in soap dispenser” as in Taiwanese Patent Publication Nos. 353362, 559188 and 392495. The soap liquid flows in container tube 20 first, then flows in a central hollow piston 30 by pressing a push block 60. From there it flows to shaft ring 40 through a central passage 35, the liquid then moves forward from holes 43 on shaft ring 40 to a outlet pipe 23 and then ready for service purpose. However the alignment problem of central passage hole 35 to shaft ring hole 43 would limit the liquid flow quantity and stability. Therefore its working performance isn't as expected. More than that, the liquid keeps flowing to container tube 20 in normal conditions till the ball valve 15 touches the soap dispenser bottom 10. The liquid in the container tube would cause resistance of the movement of hollow piston 30 which makes the operation difficult. An inlet 12 has been installed on one side of the soap outlet head 10, and outlet 13 has been installed at its bottom. Pushing the button makes the piston rod move downward till soap head stopper 27 is deviated from outlet 13 for smooth flowing of the liquid soap. The pushing resistance could be improved in such a way (for the formation of the pushing force is synchronized with outlet of liquid which results in decreased resistance). Nevertheless, its service function depends upon the matching of the mechanism manipulation to the standard liquid outlet and inlet directions, so its structure formation and service possibilities are limited. Due to shell 10, inner parts consists of soap liquid container 50 with the connection of extruding unit 20 and soap liquid extruding or tooth paste pressing out part 30 located on outer shell 10. The extruding unit 20 includes outer shell 10 and the soap liquid container 50 with connection of part 40. The first piston chamber 21 and the second piston chamber are connected with a partial opening passage, one end of pressing unit extends to first piston chamber 21 by a opening passage 211 reaching the spring 24 to the end, and the second piston chamber 22 could be accessed to the connecting part 40 by checking valve 220. There is a spring bush 27 with a valve stem installed in second piston chamber 22. The needle valve 260 is for blocking valve 220, there is spring bush 34 with valve stem 33 installed in pressing unit 30, the valve stem 33 furnishes with a needle valve 330 and is for blocking valve 32, also a releasing valve 36 has been formed at the extreme end; all the mechanisms are for activating the needle valve 260 and 330 on the blocking valves during inletting of soap liquid, so the pushing force of flowing fluid must be larger than that of extension force of spring, otherwise the needle valves of 26 and 33 wouldn't be activated, this causes an uncertainty in operation, and this uncertainty causes less quantity of soap, also its model development is limited and there is an inconvenient installation due to the extension outlet part; please see the illustration in FIG. 1 and FIG. 2, it is the vertical soap dispenser type, it is popular for shampoo and bath soap liquid, a nut A is screwed tightly on the cup of container 1, the containing tube 11 is attached on A and extends vertically to the container bottom still reaching and connecting to suction pipe 12, matching outside position indicator of the containing tube 11 to the positional seat 13 and fixed in the guiding tube 14 which is fixed in position seat 13 with a inner clip 131. This guiding tube 14 with its one end connected firmly with piston tube 17, the extension lever 171 from the extreme end of piston tube 17 and the inner key way 172, reaching the spring S in the containing tube 11, so the pushing block 16 could be activated by spring movement, where there are several inlet ports 173 on the piston tube 17, and adjacent to this inlet ports 173, a spring plug 18 to be fitted in the containing tube 11; at normal conditions the bottom of positional seat 13 pushing the spring plug 18 for sealing the inlet ports 173, stops the soap liquid flowing in (see the detailed FIG. 1 for the non feeding position); when applying force P for pushing the pushing block downward, the closed fitted spring plug 18 would move in the space prereserved, at the same time the inlet ports 173 is no more sealed by spring plug 18, and the soap liquid would flow in, and flow out through outlet tube 15 for the service, (refer to FIG. 2), the theory of transporting soap liquid from bottom up to top is suction force, so the bigger the pressure is in container, the more suction efficiency there will be, this is the reason why the aforementioned structure of shampoo and soap liquid dispenser is hard to service when the liquid in the dispenser container is less than half full. Sometimes, it's even necessary to open the cup to pour the liquid out in this condition. I believe that everybody has had this inconvenient experience before.

U.S. Pat. Nos. 6,832,916, 6,321,943, 6,467,651, 6,012,613, 5,082,150 and 2,772,817 also suffer from the above-mentioned drawbacks.

Therefore, it is an object of the present invention to provide an improved soap dispenser extruding device which can obviate and mitigate the above-mentioned drawbacks.

### SUMMARY OF THE INVENTION

The primary purpose of the present invention is to provide an extruding device for soap liquid outlet, whether the fluid in the soap dispenser is light or heavy, the position of the outlet of a soap dispenser could be set up in any direction due because of the control of the fluid leading course and the distribution of the operating zone, wherein the outlet of the soap dispenser is bolted on an inner partition plate with a nut. In the center of this plate is installed a containing ball seat, and this plate is fixed on the fluid inlet side of a containing tube body, then under the fluid inlet side of the containing tube body forms a cross containing space, and surrounding this containing space there are holes with screw thread for fluid outlet fitting, a checking valve is installed, a soap liquid feeding header with an outlet tube is screwed into the hole with its inner thread. The features are: a piston bush which is fixed in the containing space of containing tube body, for forming twin tube body set, there is a piston rod in piston bush, one end of piston rod is connected with a spring, and other end of the piston rod is fixed with a sealing lid. This sealing lid should match the shaft hole on the piston bush and once the running position of sealing lid to the shaft hole on piston bush has been fixed, this sealing lid could have a free displacement due spring force. Therefore the position of feeding direction of soap liquid is not limited and energy saving for operation is achieved and also accurate control of soap liquid outlet and stoppage of liquid after service are emerged.

Another object of the present invention is to provide an extruding device for soap liquid outlet, whether the fluid in the soap dispenser is light or heavy, the position of outlet of a soap dispenser could be settled in any direction due to control of the fluid leading course and the distribution of the operating zone, wherein the outlet of soap dispenser is bolted on a inner partition plate with a nut, in the center of this plate a containing ball seat is installed, and this plate is fixed on the fluid inlet side of a containing tube body, then under the fluid inlet side of the containing tube body a cross containing space is formed, surrounding this containing space there are holes with screw thread for fluid outlet, a checking valve is installed, and soap liquid feeding header with outlet tube screw on hole with thread. The features are: a port with possibility of closing in the sealing lid, such arrangement would induce a suction force in the containing space due to the spring force exerting to the piston at the same as the sealing lid is released back, the port on the sealing lid would be opened in response to piston movement and the suction force, therefore no liquid residues is left around the outlet of the soap dispenser.

Another object of the present invention is to provide an extruding device for the soap liquid outlet, with such design the service function of the soap dispenser is perfect whether a soap dispenser is installed in vertical position or in and up and down position as adhering on wall, due to the containing tube body which is not furnished with the outlet, or seal the original outlet then lead the liquid flowing out from outlet tube of sealing lid by using of a suction force.

Another object of the present invention is to provide an extruding device for soap dispenser, with such a design that the soap liquid wouldn't be overflowed from the hollow part of piston rod at standby service condition due the closing fitting ring between piston rod and containing space.

Another object of the present invention is to provide extruding device for soap dispenser, with such design the outlet position of a soap dispenser could be located wherever the installation space or out look of a soap dispenser is taken into consideration. It could be located at the axial direction of dispenser containing tube body; or at the radial direction of it for the best practice of human engineering, also possible for the design of a soap dispenser made in various models.

Another object of the present invention is to provide an extruding device for a soap dispenser; with such design that the fingers of a user could firmly come into contact with the pushing block of this dispenser due the clip on one end of piston bush.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a section view of a soap dispenser construction of the prior art.

FIG. 2 is an illustration for a soap dispenser operation of the prior art.

FIG. 3 is an exploded view of a preferred embodiment of the present invention.

FIG. 4 is a section view of an extruding device assembly of the present invention. (It is non feeding status).

FIG. 5 is an illustration for extruding device operation of the present invention. (It is feeding status).

FIG. 6 is a section view of extruding device in other assembly way of the present invention. (It is non feeding status)

FIG. 7 is an operation illustration for extruding device in other assembly way of the present invention. (It is feeding status)

FIG. 8 is a section view of an extruding device containing tube body of the present invention.

FIG. 9 is a section view of shell in FIG. 8.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

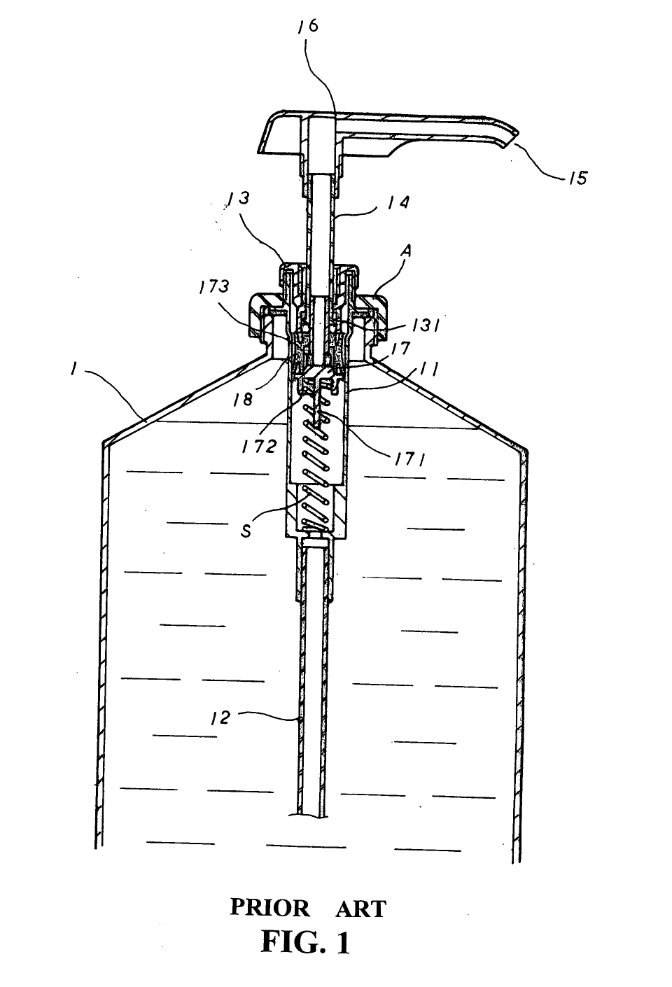

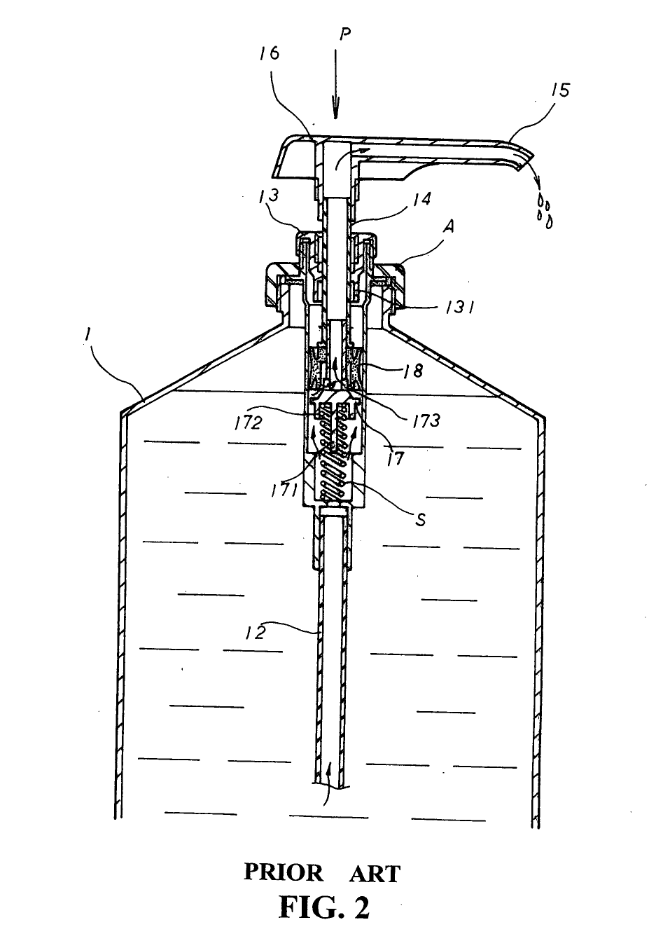

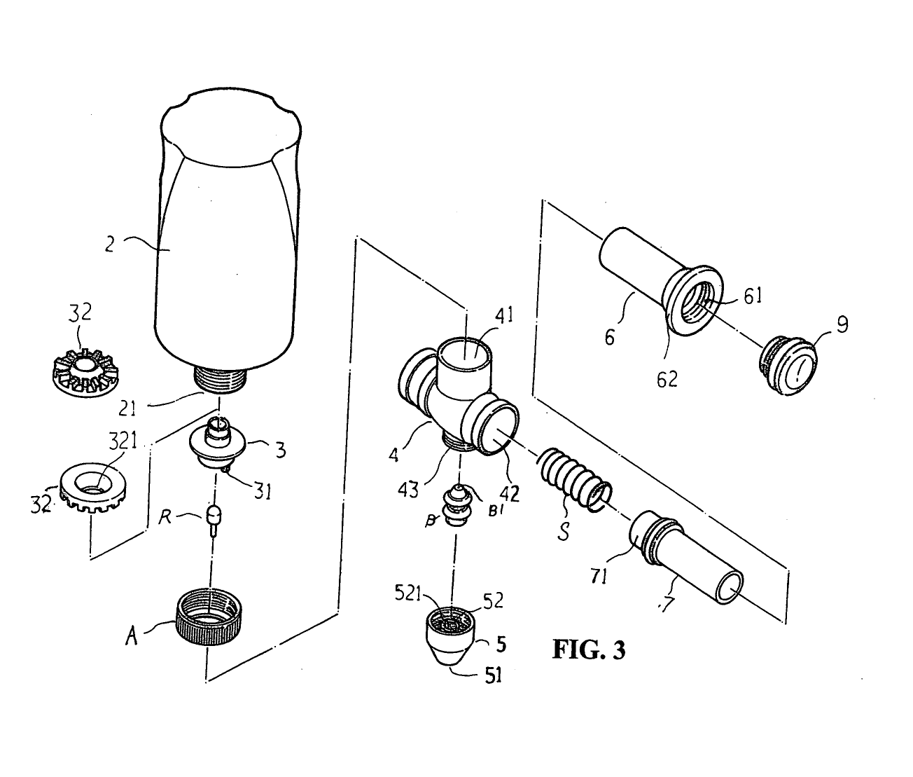

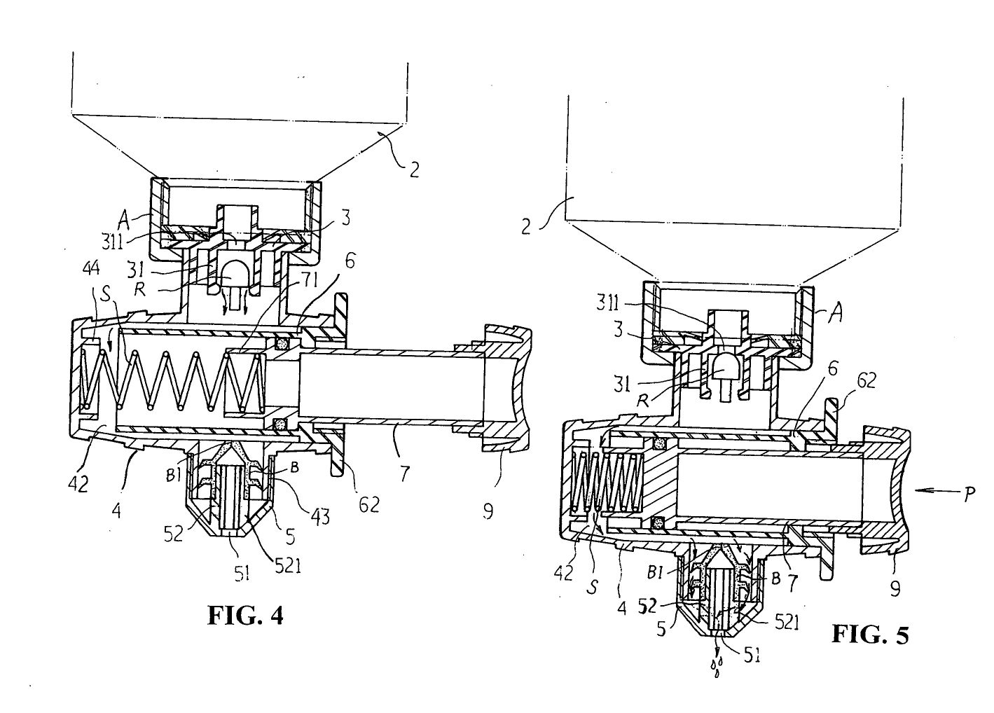

Please refer to the FIGS. 1, 2 and 3, the features of this invention are; the outlet end 21 of soap dispenser container 2 is screwed with in a shim 3 by nut A, there is a ball valve R's seat 31 in the central of shim 3, this shim 3 shall be fixed in the liquid inlet end 42 of a containing tube body 4, there is a thread outlet end 43 on containing tube body for connecting the soap liquid feeder 5 with outlet 51 by screwing on, there is a plunger with groove 521 above outlet 51 in soap liquid feeder 5, this plunger is fitted on a shut able port B1 with checking valve B, as in containing space 42 a piston bush 6 is inserted in, as in piston bush 6 a piston rod 7 against a spring S is inserted in, for the piston rod 7 is hollow in central, and a sealing lid 9 is on its other end, once this sealing lid 9 would be in free motion once out its locking position; as in normal condition the ball valve R in this design is at position as if a free fallen body, as in such a way opening the port 311 on ball valve seat 31, so the soap liquid in container could flow into containing space 42 through containing tube body 4, the checking valve B without any force being applied on it is on its original position, in order that forming a confined space with inner wall 43, then no any soap liquid would flow out from soap feeder 5 to outlet 51 (see FIG. 4); when force P is applying on sealing lid 9, the piston rod 7 would have a movement in piston bush 6, this movement cause a pushing force to lift up ball valve R, then the port 311 is blocked simultaneously, at this time the liquid in containing tube body 4, transmitting its accepted pressure activating the opening of the checking valve B, making a passage for outlet 43, so the soap liquid could flow out through outlet 51 from soap liquid feeder (see FIG. 5, soap liquid outlet operation).

A complementally explanation here for checking valve B, there is an on-off vent B1 in checking valve B for keeping outlet 51 soap liquid residues free there, because as the sealing lid 9 is free from releasing of spring force, the containing space 42 is being induced a suction force due to movement of the piston rod 7 activated by a spring force, the falling down of ball valve R on its seat making the opening of port 311, so the soap liquid could flow into containing space 42 smoothly, at the same time a little opening of the checking valve B caused a suction force to the soap liquid between soap feeder 5 and outlet 51, so no soap liquid residue there as the sealing lid is in its original position.

Moreover, the end 71 of piston rod 7 is fitted with a seal in a retainer, for keeping overflow of soap liquid in containing space from piston rod. And there is a finger holder 63 on the one end of piston bush 6 for convenient of activating the soap dispenser; there is an inner screw on side of finger holder 63 for holding the sealing lid in a security position before commissioning of a soap dispenser 2.

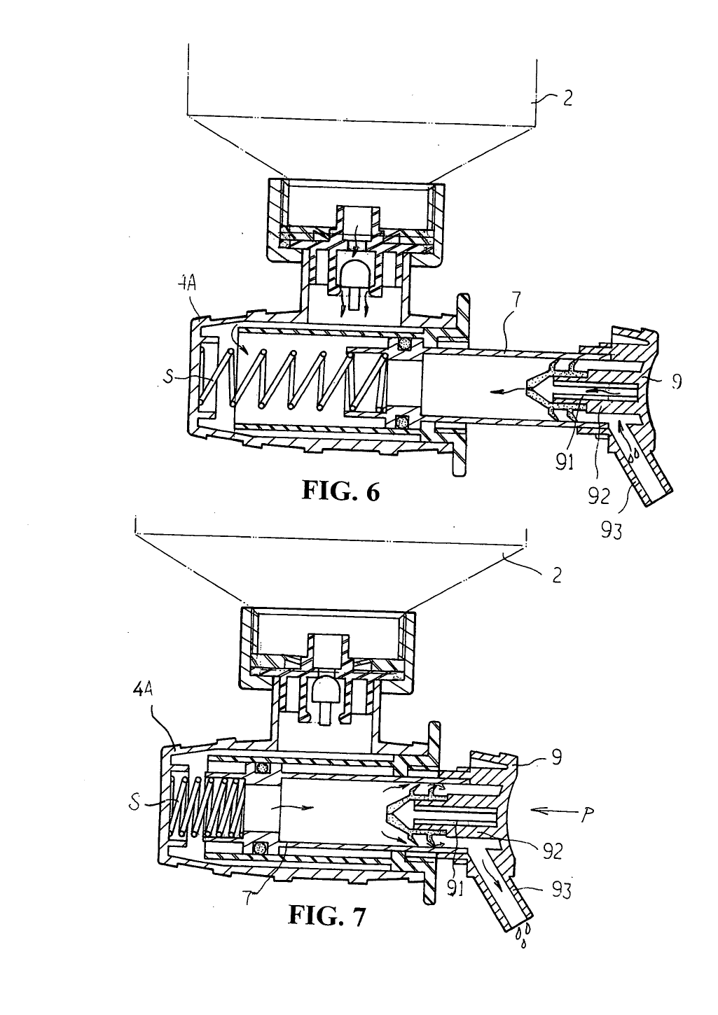

Besides, (see FIGS. 6 and 7 for illustration) the structure design in this invention can alternate containing tube body 4A into one without outlet 43, or blocking the original outlet 43 and then secure the sealing lid 9 with piston rod 7, there is a plunger 92 with groove 91 inserting in a bush with a checking valve B outside, and the whole unit is installed in central inner side of sealing lid 9, there is an outlet 93 on the side of sealing lid 9, using the piston rod 7 end fitting with spring S in containing tube body 4A, in order a movement of sealing lid 9 could be activated by spring; in normal condition the checking valve B would seal outlet 93 accurately, therefore there would be no any soap liquid reaching outlet 93 (refer to FIG. 6, this is soap dispenser out of service condition); as a pushing force P press sealing lid inward, the tight fitted checking valve B contract inward therefore the soap liquid in the hollow part of piston rod could passing by it and flow out through outlet 93 (as shown in FIG. 7), in such circumstance a soap dispenser can feed soap liquid whether its soap container is in position of vertical or up and down as adhering on wall.

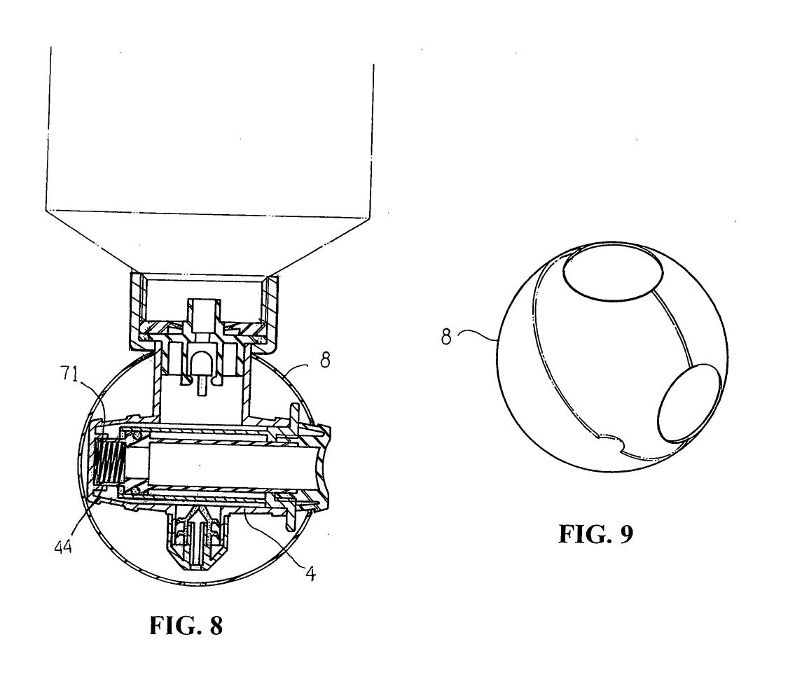

Please refer to FIGS. 8 and 9, the position of a soap dispenser outlet could be alternated with the requirement of its installation space and out looking, such as along containing tube body 4 both axial sides or any its radial direction, for matching different appearance of outer shell 8 to produce varies model of soap dispenser.

As the aforementioned, the caption invention focus on a soap dispenser extruding device with simplifying its construction member, producing cost deduction, high human engineering consideration due the possibility of its outlet position alternation, and with no residue to be left around its outlet after service would prove its practice service function.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A invention of a extruding device for soap liquid outlet, regardless of light fluid or heavy fluid in soap dispenser, the controlling of fluid leading route and the distribution of operating zone, the position of outlet of a soap dispenser could be set up in any direction; wherein bolting the outlet of a soap dispenser on a inner partition plate with a nut, in the center of this plate is installed a containing ball seat, and fixing this plate on the fluid inlet side of a containing tube body, then under the fluid inlet side the containing tube body forms a cross containing space; holes with inner thread for fixing the outlet surrounding this containing space; using a one way checking valve for soap liquid feeding header with outlet tube screwed into hole with its inner thread; the features comprising; fixing piston bush in containing space of containing tube body for forming twin tube body set; inserting a piston rod with one end connecting spring and other end fixed to a sealing lid into piston bush; matching this sealing lid with the shaft hole on piston bush; once the running position of sealing lid to the shaft hole on piston bush is fixed, following a free displacement of this sealing lid due spring force, the achievement of desirable position of feeding direction setting, energy saving for operation, and accurate control of liquid outlet and stoppage during and after soap dispenser service.

2. A invention of a extruding device for soap liquid outlet, regardless of light fluid or heavy fluid in soap dispenser, the controlling of fluid leading route and the distribution of operating zone, the position of the outlet of a soap dispenser could be set up in any direction; wherein bolting the outlet of a soap dispenser on a inner partition plate with a nut, in the center of this plate installing a containing ball seat, and fixing this plate on the fluid inlet side of a containing tube body, then under the fluid inlet side the containing tube body a cross containing space is formed, holes with inner thread for fixing outlet surrounding this containing space, using a one way checking valve for soap liquid feeding header with outlet tube screw into hole with its inner thread, the features comprising; a possible closing vent on checking valve for inducing a suction force containing space due to the releasing of sealing lid and activating spring force to piston rod at the same time, causing a little suction force there due the vent on checking valve's slight opening, no liquid residue is left.

3. The soap dispenser as claimed in claim 1, wherein a invention of a extruding device for soap outlet, redesigning the containing tube body without liquid outlet, or sealing the original liquid outlet, leading the soap liquid flowing from sealing lid outlet piping by suction force, obtaining a well functioning soap dispenser in such a way regardless of being vertical or up and down as wall adhering type position of a soap dispenser.

4. The soap dispenser as claimed in claim 1, wherein a invention of a extruding device for soap outlet, in which fitting a seal on the piston rod end retainer at containing space end, so making the flowing of the soap liquid in containing space to piston rod impossible, and then no overflowing of soap liquid before soap dispenser stand-by in service.

5. The soap dispenser as claimed in claim 1, wherein an invention of an extruding device for soap outlet, in which fitting a finger holding button on the end of the piston bush for convenient operation.

6. The soap dispenser as claimed in claim 1, wherein an invention of an extruding device for soap outlet, in which installing the liquid outlet at a desirable orientation as by both sides of containing tube body or its radial directions for matching different outer shell design, so obtaining various product model.
